(19) United States
(12) Patent Application Publication
(10) Pub. No.: US 2012/0160145 A1
(43) Pub. Date: Jun. 28, 2012

(54) APPARATUS AND METHOD FOR REDUCING THE MANUVERABILITY AND SPEED OF A MOVING SHIP

(76) Inventor: Guy Gavish, Tel Aviv (IL)

(21) Appl. No.: 13/393,553

(22) PCT Filed: Aug. 26, 2010
(86) PCT No.: PCT/IL10/00697

§ 371 Date: Mar. 1, 2012

Related U.S. Application Data
(60) Provisional application No. 61/241,880, filed on Sep. 12, 2009.

(30) Foreign Application Priority Data
May 3, 2010 (IL) 205507

(51) Int. Cl. B63H 25/44; B63H 23/00

(52) U.S. Cl. 114/145 R; 440/74

(57) ABSTRACT

The invention discloses an apparatus for reducing maneuverability of a moving ship. The apparatus comprises a propeller fouling element, mountable upon the bow of a second ship. The proper fouling element is deployable towards a propeller of a moving ship. The invention further discloses a rudder engaging component. In one embodiment, the rudder engaging component is U-shaped for accepting a rudder within. The invention also provides a method for reducing the maneuverability of a moving ship, by providing the rudder engaging component and/or the propeller fouling element. The rudder engaging component, when present, is advanced to engage and surround the rudder of the ship. The propeller fouling element is advanced towards a propeller of a ship until it contacts the propeller; thereby reducing the maneuverability of said ship.

### FIELD OF THE INVENTION

The invention pertains to means for effectively reducing maneuverability and speed of a moving ship.

### BACKGROUND OF THE INVENTION

At times the need arises to slow moving vessel mid-water. It is difficult for a third party to compel a large vessel to slow due to the mass and velocity that a large ship may have. The steering and propulsion machinery is usually located at the transom (rear end) of the vessel, making access to them difficult for a third party wishing to effectively reduce the maneuverability and speed of the moving vessel. The force generated by the engines is immense, and in some vessels can be measured in the tens thousands of horsepower.

The need exists for an effective device and method for effectively and subtly reducing the maneuverability and speed of a moving vessel. The device should be deployed without causing damage to the hull of the target vessel. It is the object of the present invention to provide an effective device and method of slowing a moving ship, and limiting its maneuverability. These and other objects will be discussed in greater detail in the detailed description that follows.

### SUMMARY OF THE INVENTION

The invention hereby provides an apparatus for reducing maneuverability of a moving ship. The apparatus comprises a propeller fouling element, mountable upon the bow of a high speed small craft, which may be controlled remotely. The proper fouling element is deployable towards a propeller of a moving ship.

Optionally, the apparatus further comprises a rudder engaging component, mountable upon the high speed small craft.

In one aspect of the invention, the rudder engaging component has an open position for accepting a rudder within, and an engaged position for holding a rudder within.

Further, the rudder engaging component may be U-shaped, having two arms for accepting a rudder within. Optionally, a locking pin may be present, movable to engage the two arms and lock the rudder within.

Moreover, the rudder engaging component may be mountable upon an unmanned surface vehicle (USV).

In certain embodiments, an underwater camera is included, for transmitting images of a rudder of the moving ship.

According to certain aspects of the invention, the angle and distance of the rudder engaging component from the second ship may be controlled by a user.

Further, the angle and distance of the rudder propeller fouling element from the second ship may be controlled by a user.

Still further, the rudder engaging component arms may be adjustable to be extended or retracted in any direction, to correspond to the length and width of the rudder of the moving ship.

Moreover, the propeller fouling element may be spear shaped.

According to one embodiment, the invention further comprises a propulsion mechanism for propelling the propeller fouling element towards a propeller. The propulsion mechanism may be selected from at least one of the following: compressed air, hydraulic pressure, pyrotechnic device, spring mechanism, and an electrical motor.

Additionally, a plurality of propeller fouling elements may be present.

In some embodiments, the propeller fouling element comprises at least one of the following: a plurality of anchoring spikes; detonation elements, and a foam.

Further, the rudder engaging component may comprise a plurality of arms for engaging a rudder.

Additionally, the rudder engaging component may include a mechanism for rapidly detaching the rudder engaging component from the second ship.

Moreover, the rudder engaging component may be self propelled.

Furthermore, the invention may include a timing mechanism for deployment of the propeller fouling element

Additionally, the invention may include a deployment mechanism for deploying the propeller fouling element when a predetermined small craft speed is reached.

The invention further provides a method for reducing maneuverability of a moving ship, comprising providing at least one of:

a rudder engaging component or a propeller fouling element;
advancing the rudder engaging component to engage and surround the rudder of the moving ship; or advancing the propeller fouling element towards a propeller of a moving ship until the propeller fouling element contacts the propeller.

### BRIEF DESCRIPTION OF THE DRAWINGS

The present invention is illustrated by way of example in the figures of the accompanying drawings, in which like references indicate similar elements and in which:

FIG. 1 illustrates a perspective view of the rudder engaging component and propeller fouling mechanism of the invention, mounted upon the bow of a high speed small craft.

FIG. 2 illustrates the rudder engaging component of the invention, surrounding the rudder of a target vessel.

FIG. 3 illustrates the rudder engaging component of the invention, after locking pin has closed around rudder.

FIG. 4 illustrates a top view of rudder engaging component, cross-bars, and locking pin of the invention, after rudder has been surrounded by rudder engaging component.

FIG. 5A illustrates a top view of rudder engaging component, with locking pin closed to engage both arms of rudder engaging component and thus lock rudder within.

FIG. 5B illustrates a rudder engaging component including an upper limiter for engaging the top portion of a rudder.

FIG. 6A illustrates a propeller fouling element.

FIG. 6B illustrates propeller fouling elements projecting into blades of propeller.

FIG. 7 and FIG. 8 illustrate propeller fouling element including a propulsion mechanism.

FIG. 9 illustrates several propeller fouling elements.

FIG. 10A illustrates propeller fouling elements including spike anchors.

FIG. 10B illustrates one embodiment of a propeller fouling element.

FIG. 10C illustrates an embodiment of several propeller fouling elements, some of which are angled to correspond to the propeller pitch angle of the target vessel.

FIGS. 11A, 11B illustrate use of the invention with various types of propellers located within a nozzle.

FIG. 12 illustrates initialization of the invention.

### DETAILED DESCRIPTION OF THE INVENTION

In the following detailed description, numerous specific details are set forth in order to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

The invention generally comprises a propeller-fouling element mounted on the bow of the high speed small craft. Upon its deployment, the propeller-fouling element is launched forcefully towards the propeller, and enters the gap between the propeller blades, where it acts to inhibit efficient maneuvering of the target vessel.

In a presently preferred embodiment, a rudder engaging component is also included in the invention, and is mounted on the bow of a high-speed small craft operated or remote-controlled by third party personnel. The rudder engaging component can be advanced towards the rudder and propeller of the target ship, to act in combination with the propeller fouling element such that the rudder of the target vessel becomes dislocated from its rudder post mounting. The target vessel can then no longer be sailed efficiently, so that maneuverability and speed are reduced mid-water.

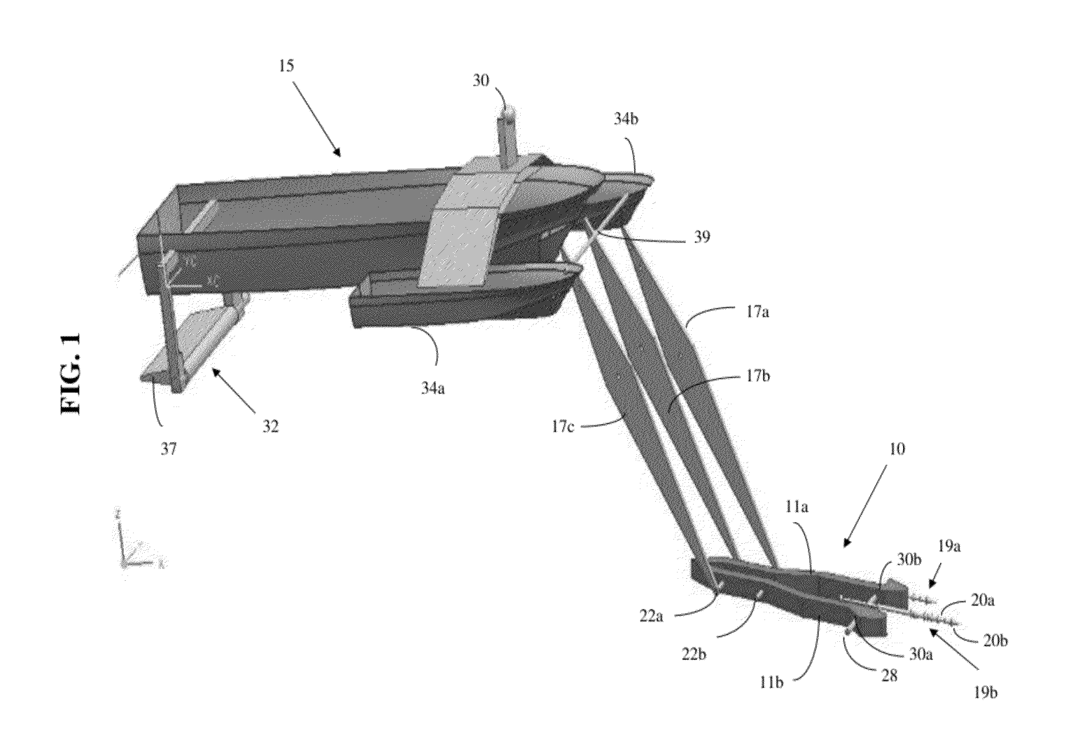

Referring to FIG. 1, rudder engaging component 10 is U-shaped, having arms 11a, 11b. Rudder engaging component 10 is mounted on the bow of a high-speed small craft 15 via booms 17a, 17b, 17c, of which one or more may be hydraulic cylinders which allow adjustment of the angle, height and distance of rudder engaging component 10 in relation to small craft 15. Cross-bars 22a, 22b, and upper cross bar 39, connect booms 17a-c to arms 11a, 11b of rudder engaging component 10.

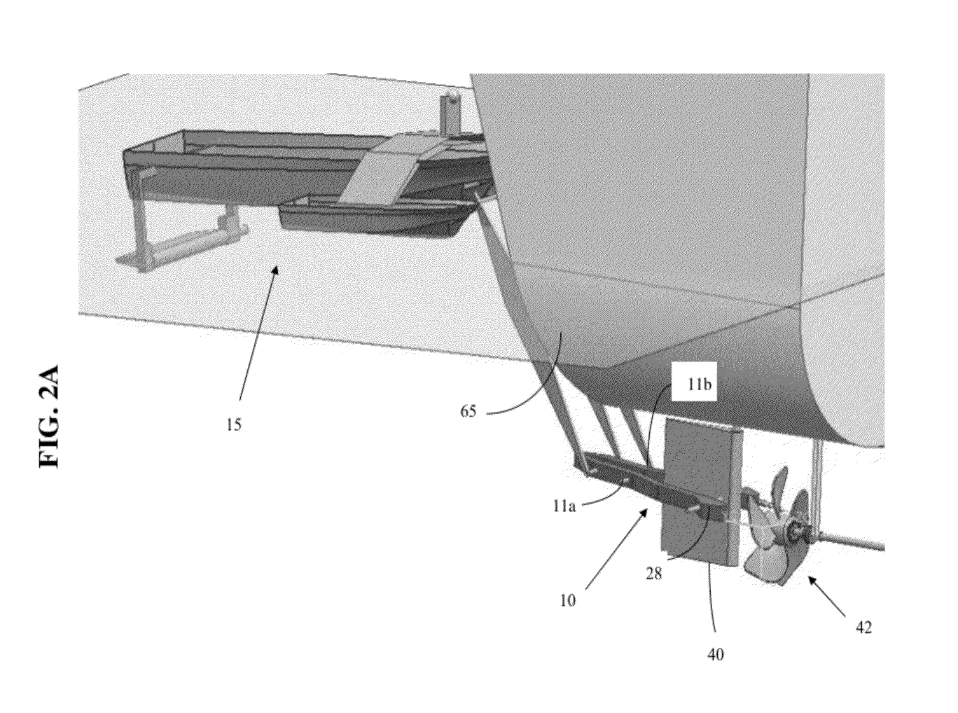

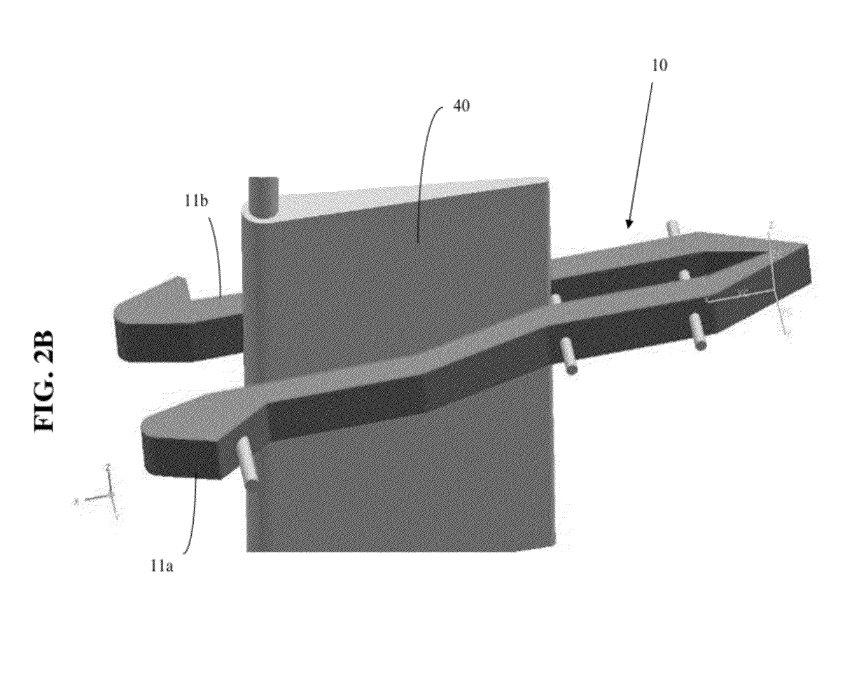

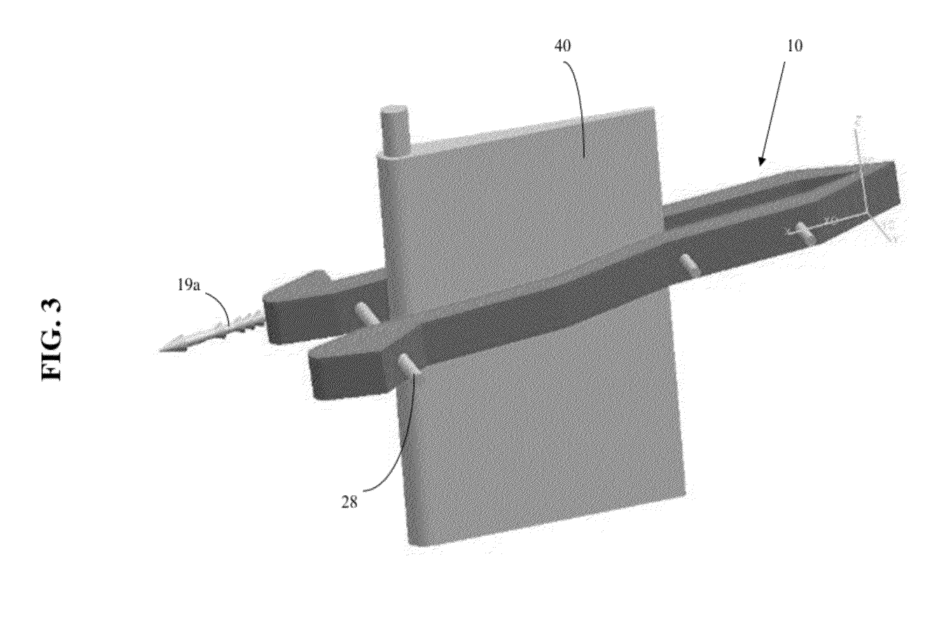

Propeller fouling elements 19a, 19b extend forward of the rudder engaging component 10. Propeller fouling elements 19a, 19b are pointed spears with ridges 20a, 20b. Locking pin 28, best described in relation to FIGS. 2 and 3 may advance or retract within bores 30a, 30b, located on front portion of arms 11a, 11b of rudder engaging component 10. Thus, prior to deployment, locking pin 28 is retracted, leaving the interior of rudder engaging component 10 open to accept a rudder within. Movement of locking pin 28 within bores will be described further in relation to FIGS. 2 and 3.

Referring to FIG. 2A, use of the invention will now be described, according to the method for reducing maneuverability of a moving ship. Small craft 15 sails astern of the target vessel towards the transom 65 (rear end) of the target vessel. Rudder engaging component 10 is advanced towards the rudder 40 of target vessel, using remote controls and images transmitted from cameras mounted on high speed small craft 15, to correctly position rudder engaging component 10 at the ideal angle and location to engage the rudder 40 within both arms 11a, 11b of rudder engaging component 10. Locking pin 28 is in open position, to allow entry of rudder 40 within arms 11a, 11b of rudder engaging component 10.

Referring to FIG. 2B, rudder engaging component 10 is shown in cut-off view without additional elements of the invention, for illustrative purposes only. Rudder 40 is engaged within rudder engaging component 10, while locking pin 28 is in open position.

Referring to FIG. 3, locking pin 28 has been closed by advancing it within its bores 30a, 30b, to engage both arms 11a, 11b of rudder engaging component, and thus to lock the rudder 40 within rudder engaging component 10.

When both propeller fouling element and rudder engaging component are present, their joint action will prevent the maneuverability and reduce the speed of the moving target ship. In some instances, the rudder of the moving ship will be dislocated from its rudder post.

Propeller fouling element 19a is seen projecting from rudder engaging component 10 towards propeller (not shown).

In certain embodiments of the invention, rudder arms 11a, 11b are adjustable telescoping arms, which may be extended or retracted in any direction, to adjust for the length and width of different rudders which may be encountered.

Without being bound by theory, the rudder engaging component and propeller fouling element of the invention utilize directional forces produced by target vessel, without need of additional massive forces to reduce maneuverability of target vessel. This is in contrast to prior art methods for stopping or reducing speed or maneuverability of a moving vessel.

In some embodiments, rudder engaging component includes a mechanism for rapidly detaching the rudder engaging component from the small craft. In use, after rudder engaging component has engaged and locked the rudder of the target vessel, rudder engaging component will be rapidly detached from the small craft, which may prevent impact of small craft with target vessel.

Small craft 15 may be an unmanned surface vessel (USV), or may be a submersible vessel which is manned or unmanned. Use of unmanned vessels controlled by personnel at a distant location, lowers the chance of injury. As unmanned vessels may be costly and not present at a given time, the invention may be utilized with any type of craft.

Referring back to FIG. 1, small craft 15 is depicted as a high speed unmanned surface vessel (USV). USVs are well known in the art, and contain well known elements for ensuring remote control, and for advancement of the craft on its proper course.

Camera 30 is located above the water surface and its images are transmitted to personnel to aid in positioning of the vessel. Underwater camera (not shown) may be included on the bow of small craft 15, to transmit images of the rudder engaging component and aid personnel in precise positioning of rudder engaging component to engage the rudder of target vessel.

Rear stabilizer 32 and fore-stabilizers 34a, 34b may be included in small craft 15 to promote stability of craft. Optionally, remote personnel may control angle of flap 37 on rear stabilizer 32, which may aid in achieving a rapid approach to the target vessel, without capsizing the small craft 15.

Optionally, stabilizers may be included on the rudder engaging component 10 and/or on the propeller fouling elements 19a, 19b.

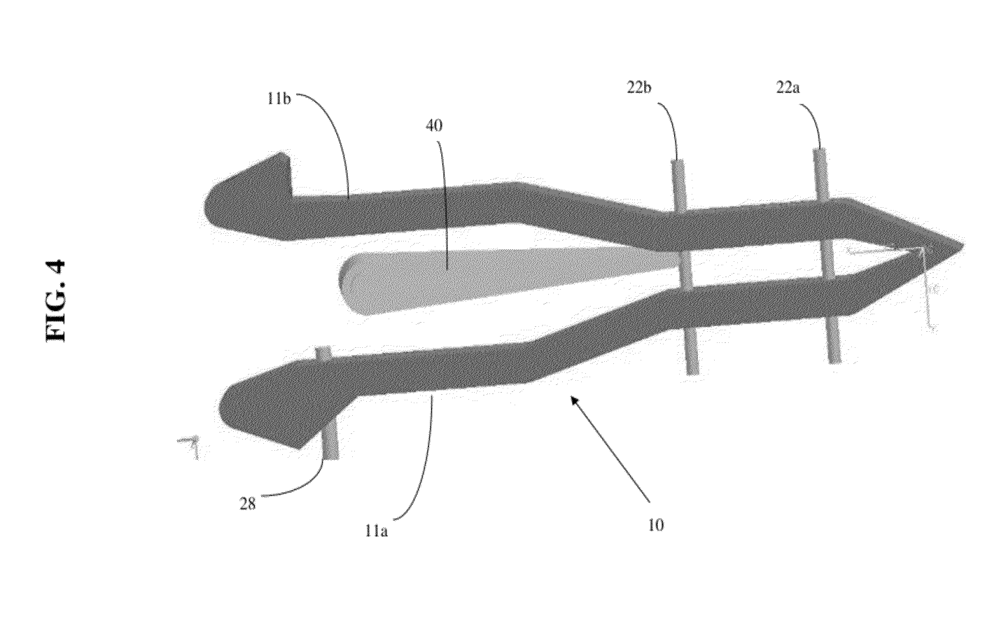

FIG. 4 illustrates a top view of rudder engaging component, cross-bars, and locking pin of the invention, after rudder 40 has been surrounded by rudder engaging component 10.

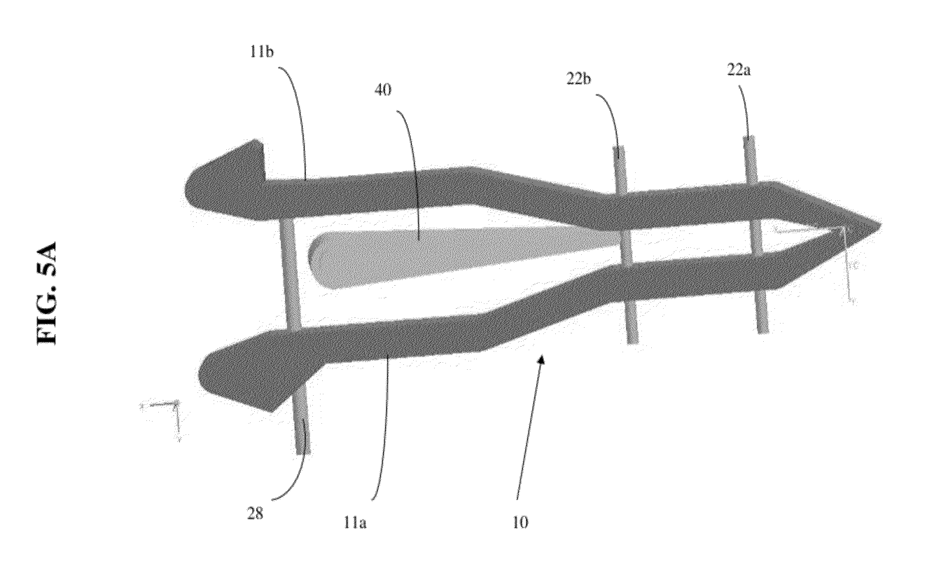

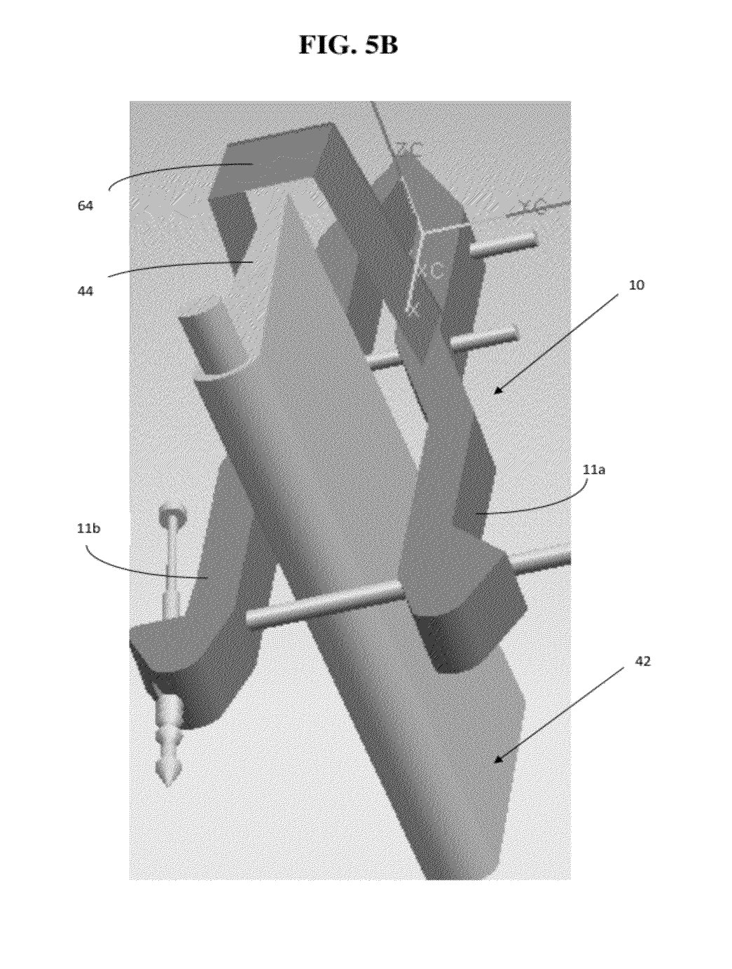

FIG. 5A illustrates a top view of rudder engaging component 10, with locking pin 28 closed to engage both arms 11a, 11b of rudder engaging component 10 and thus lock rudder 40 within.

Referring to FIG. 5B, according to some embodiments, rudder engaging component 10 includes an upper limiter 64 for engaging a rudder. Upper limiter 64 is an adjustable bracket for engaging the top portion 44 of the rudder 40, and acts to ensure alignment of rudder 40 within rudder engaging component 10. Upper limiter 64 is attached to each of arms 11a, 11b of rudder engaging component 10. The height of upper limiter 64 may be adjusted to suit various heights of rudders 40.

In certain embodiments, the rudder engaging component and/or the propeller fouling element may be self propelled. Optionally, a propulsion mechanism may be included to advance rudder engaging element rapidly towards the rudder of the moving vessel, or to advance propeller fouling element rapidly towards the propeller of the moving vessel. In some instances, these components are not mounted on a high speed craft, rather they are propelled towards the target vessel after being deployed either from shore or from a waiting vessel.

In certain embodiments, deployment of a propeller fouling element is activated by a timing mechanism. In other cases, deployment is activated when a predetermined target vessel speed is reached.

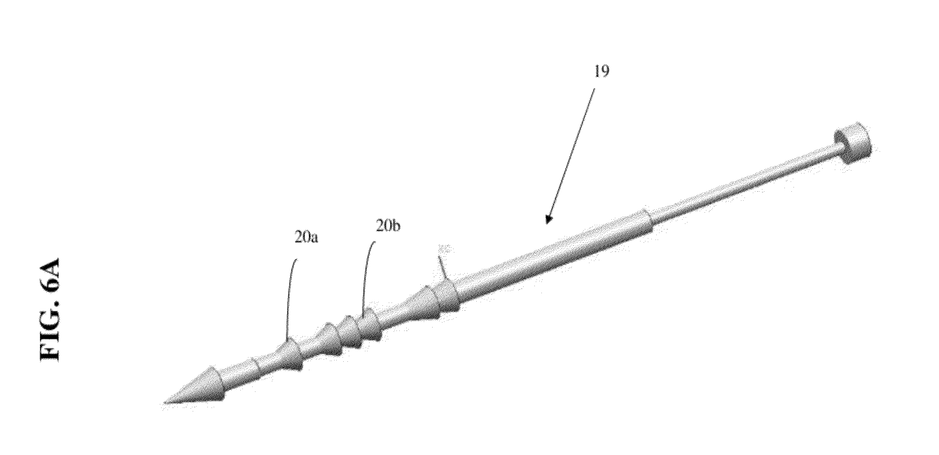

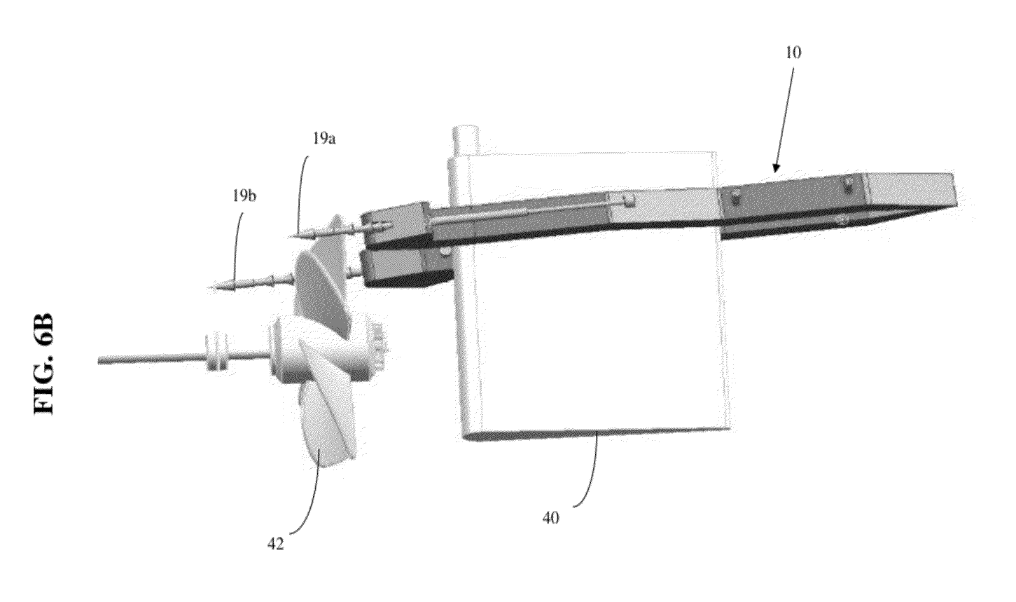

Referring to FIG. 6A, a spear shaped propeller fouling element 19 is illustrated, having ridges 20a, 20b. In certain embodiments, ridges 20a, 20b ensure engagement of propeller and enact maximum damage on propeller. In other embodiments, propeller fouling element 19 is telescoping, to suit various distances between propeller and rudder, thereby allowing adjustment of the length of propeller fouling element 19 by the user, and guaranteeing that the propeller fouling element 19 will successfully engage the propeller.

Referring to FIG. 6B, two spear-shaped propeller fouling elements 19a, 19b, are depicted projecting from rudder engaging component 10 after rudder 40 has been engaged and locked within rudder engaging component 10. In this embodiment, propeller fouling elements 19a, 19b are static, and are held in place in arms 11a, 11b of rudder engaging component to project towards blades of propeller 42, and interfere with rotation of the propeller 42, and thus contribute towards stopping the vessel.

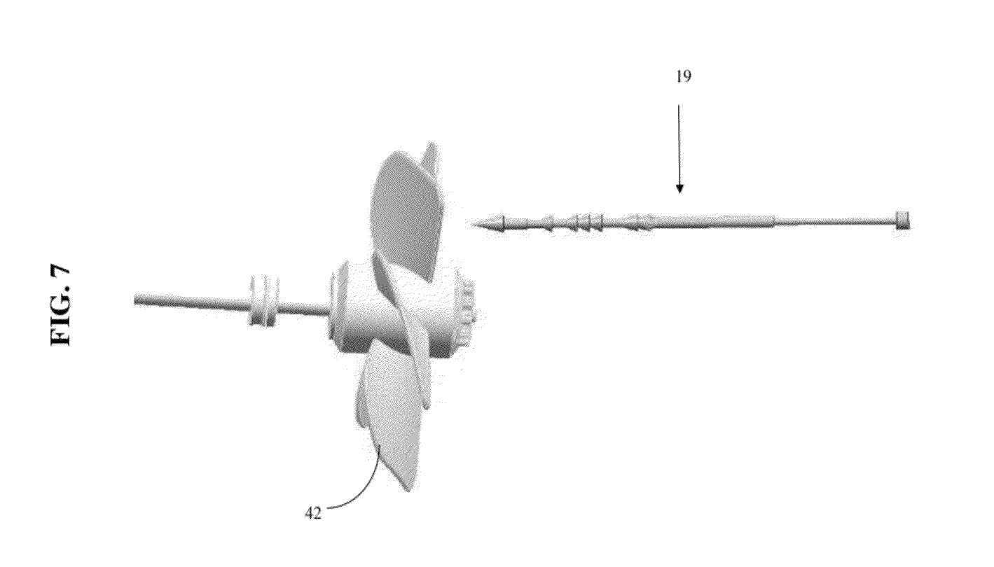

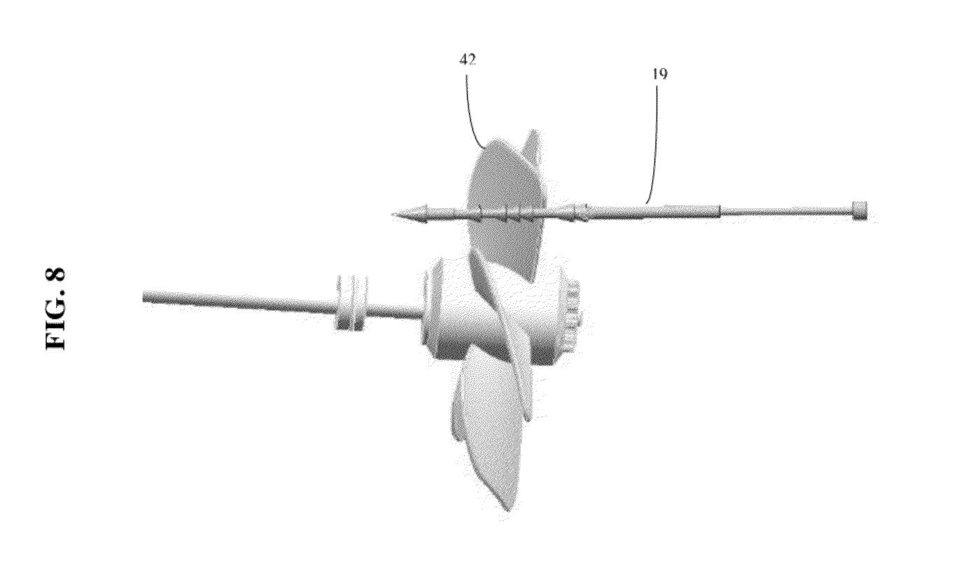

Referring to FIG. 7 and FIG. 8, in the embodiment shown, propeller fouling element 19 includes a propulsion mechanism, such as a compressed air canister (not shown), hydraulic pressure, pyrotechnic device, spring mechanism, electrical motor, which can be controlled at the proper moment to deploy the propeller fouling element 19 towards the propeller 42. Referring to FIG. 7, propeller fouling element has been deployed and has begun to move underwater towards propeller 42. Referring to FIG. 8, propeller fouling element 19 has reached propeller 42 and interferes with rotation of propeller 42.

Propeller fouling element, when deployed, is launched forcefully against the flow generated by the propeller. The propeller fouling element is propelled by its launching mechanism, or otherwise advanced, towards the gap between the propeller blades.

In a presently preferred embodiment, the propeller fouling element is deployed at an angle corresponding to the propeller pitch angle of the target vessel. Thus the propeller fouling element will not strike the center of any of the propeller blades, rather will enter between the blades.

Without being bound by theory, when the propeller fouling element contacts the fore-edge of one of the propeller blades, it is pulled by the immense propelling force into the propeller, which becomes inoperable or inefficient. Optionally, the rear end of the propeller fouling element remains attached to the rudder engaging component by a connecting cable, therefore joint action of the propeller fouling element and the rudder engaging component results in distortion of the rudder or dislocation of the rudder from its rudder post mounting.

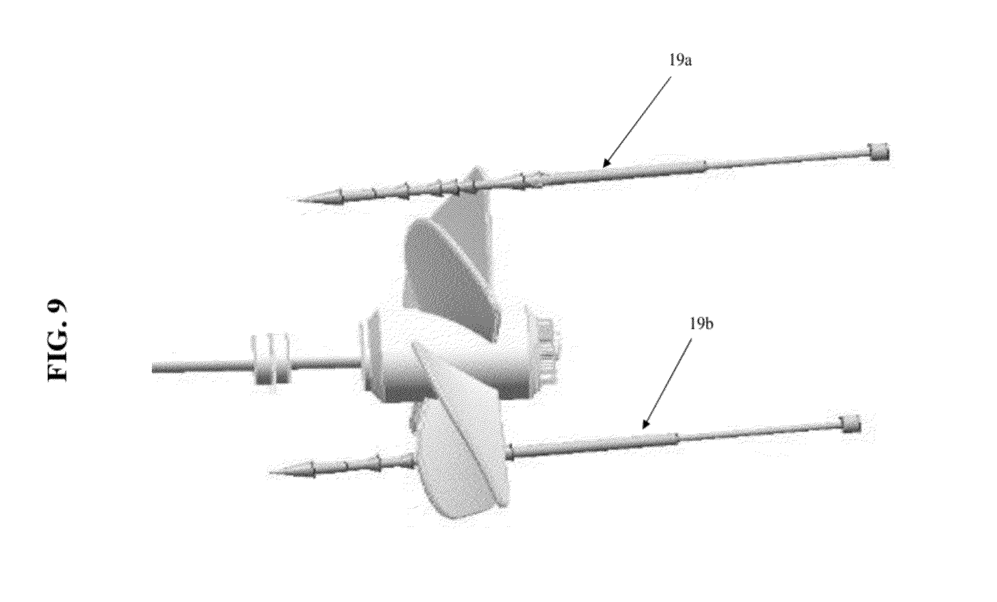

Referring to FIG. 9, any number of propeller fouling elements 19a, 19b may be included in the apparatus of the invention, and may be statically projecting from the rudder engaging component or may be deployed and propelled towards the propeller.

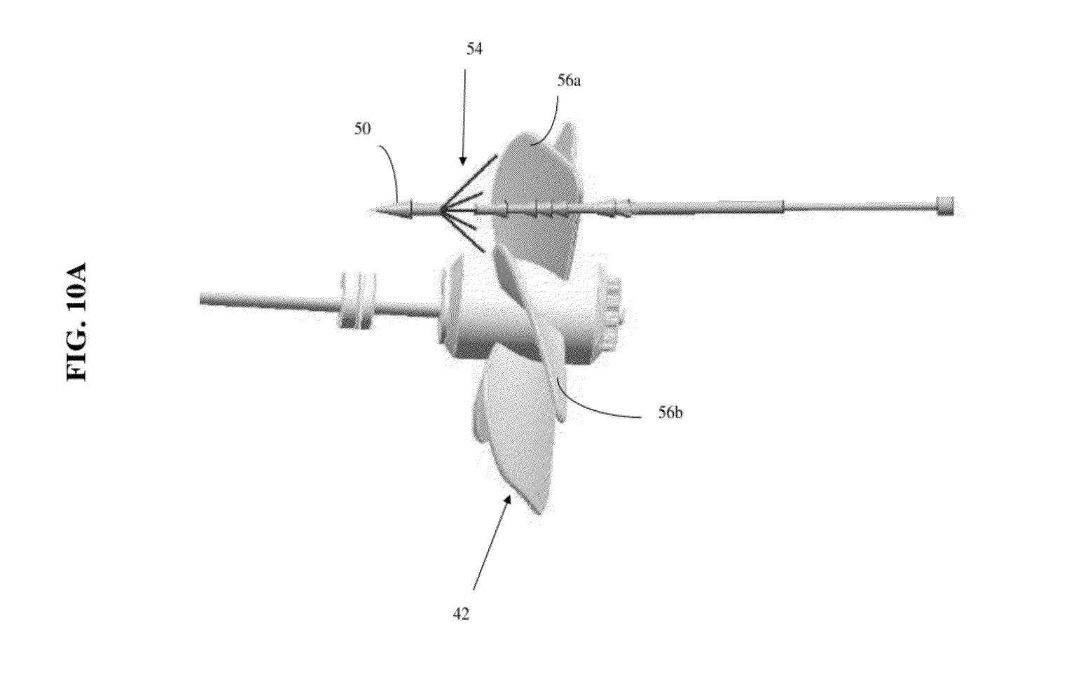

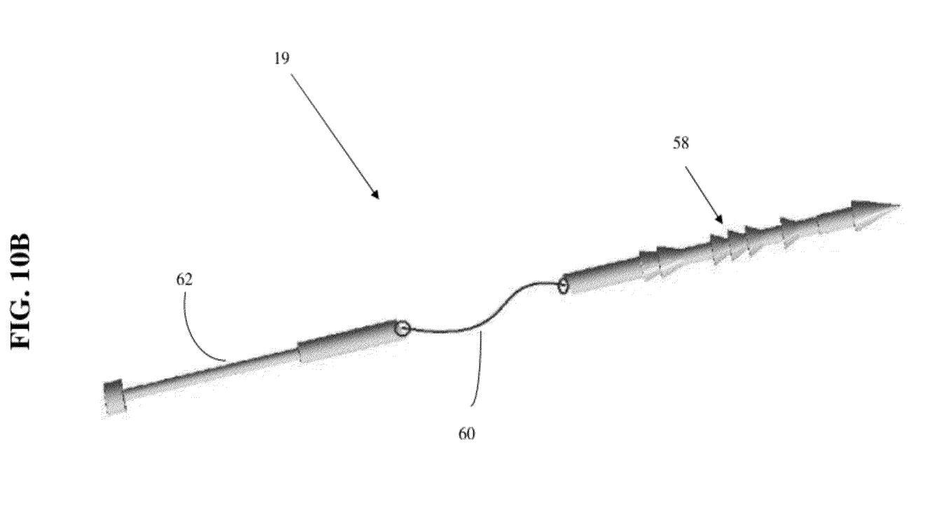

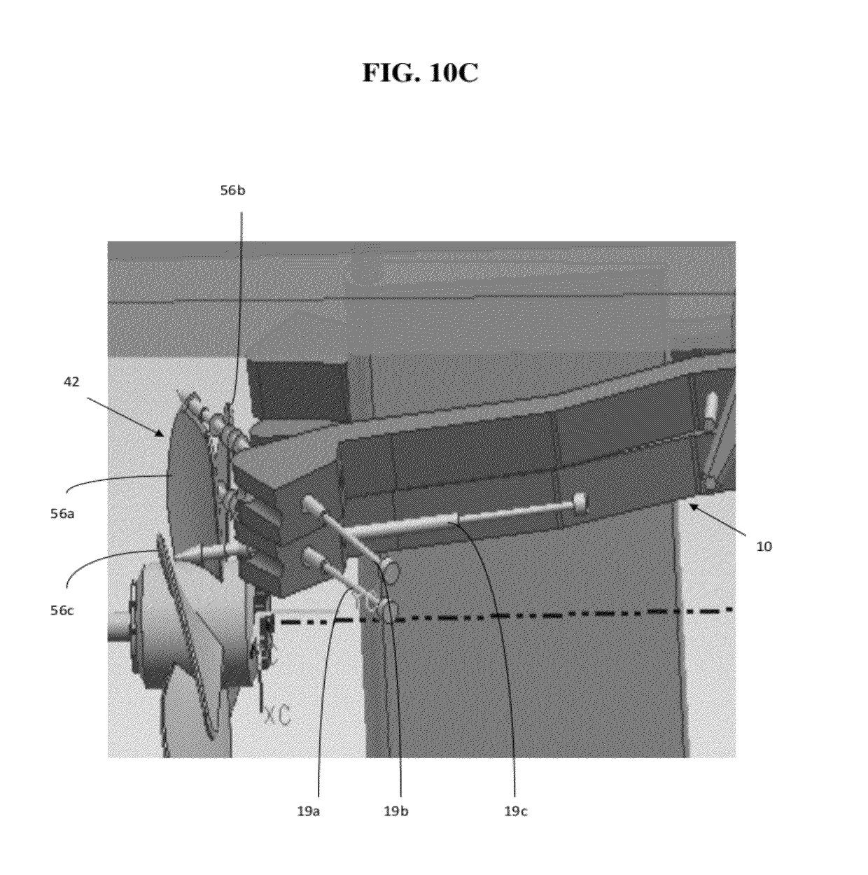

Referring to FIG. 10A, propeller fouling element may include a spear head 50 which may be activated to release several spikes 54 which anchor propeller fouling element within propeller blades 56a, 56b.

Referring to FIG. 10B, in some embodiments, propeller fouling element 19 has a forward portion 58 which is propelled towards propeller 42 upon deployment. Cable 60, representing a middle portion of the propeller fouling element, remains attached to rear portion 62 of propeller fouling element. Rear portion 62 remains upon rudder engaging component 10 (not shown).

Referring to FIG. 10C, several propeller fouling elements 19a, 19b, 19c are depicted, while certain of these (19a, 19b) are positioned at an angle corresponding to the propeller pitch angle of the target vessel, so that when deployed they will enter the gap between the propeller blades 56a, 56b. Propeller fouling element 19c is parallel with the horizon, and will be deployed forward to enter between propeller blades 56a, 56c. The propeller fouling elements may be deployed simultaneously or with a brief time delay between their deployment.

In other embodiments, propeller fouling element may release a small detonation which will harm the propeller without breaching the hull of the moving vessel. In another embodiment, the propeller releasing element may release a foam which interferes with proper rotation of the propeller.

In certain embodiments, the rudder engaging component and propeller fouling mechanism of the invention are towed upon tow ropes between two small craft high speed vessels, which surround the target vessel after approaching the target vessel from behind. This flanking action will bring the invention around the rudder of the target vessel located between the flanking small crafts.

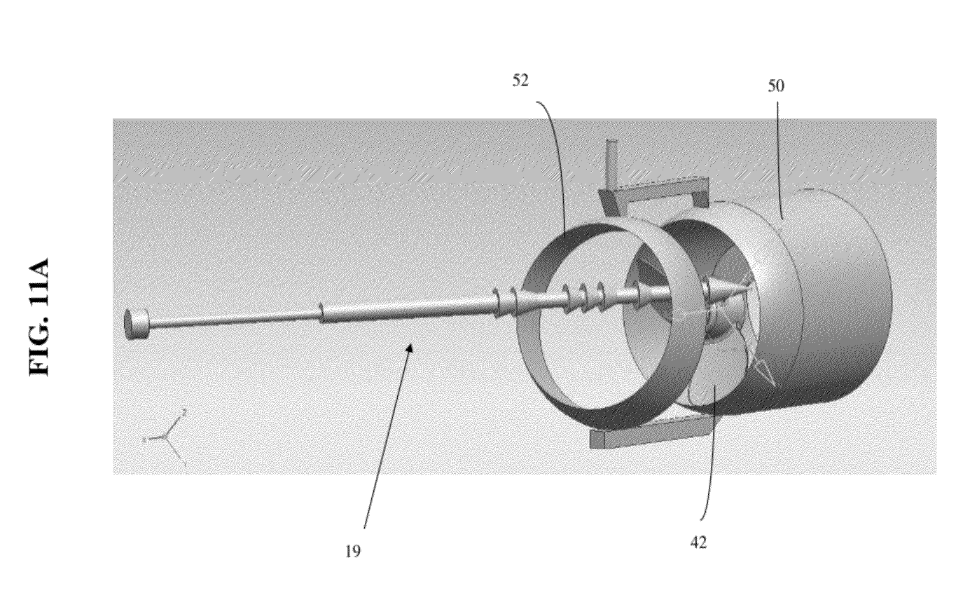

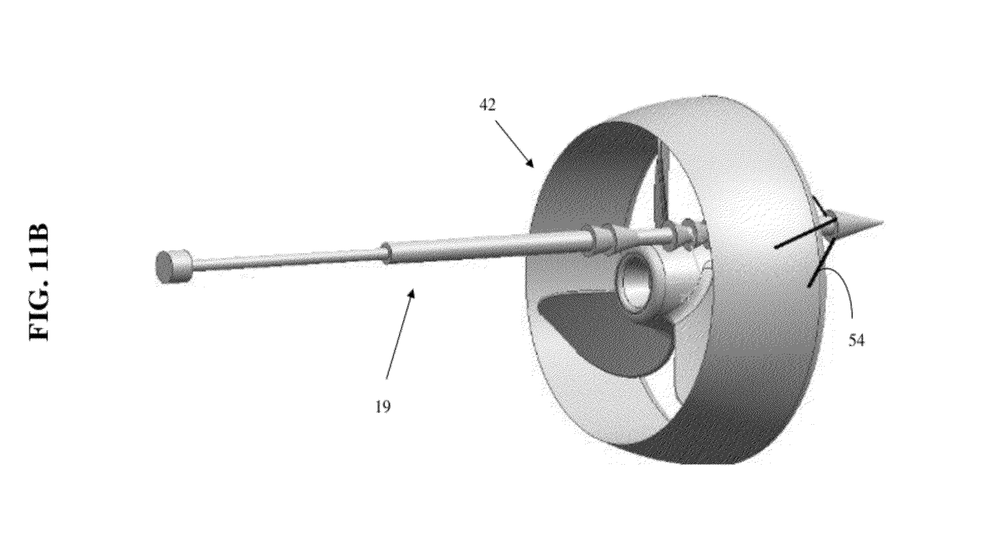

Referring to FIG. 11A, certain propellers, of the water jet type, are located within a nozzle 50, and are termed internal impellers 42. Directional nozzle 52 replaces standard rudder. The propeller fouling element 19 will then be directed into the nozzle 50 to reach the impeller 42.

Referring to FIG. 11B, Kort nozzle type impeller 42 is illustrated, after propeller fouling element 19 has entered impeller and spikes 54 have been deployed.

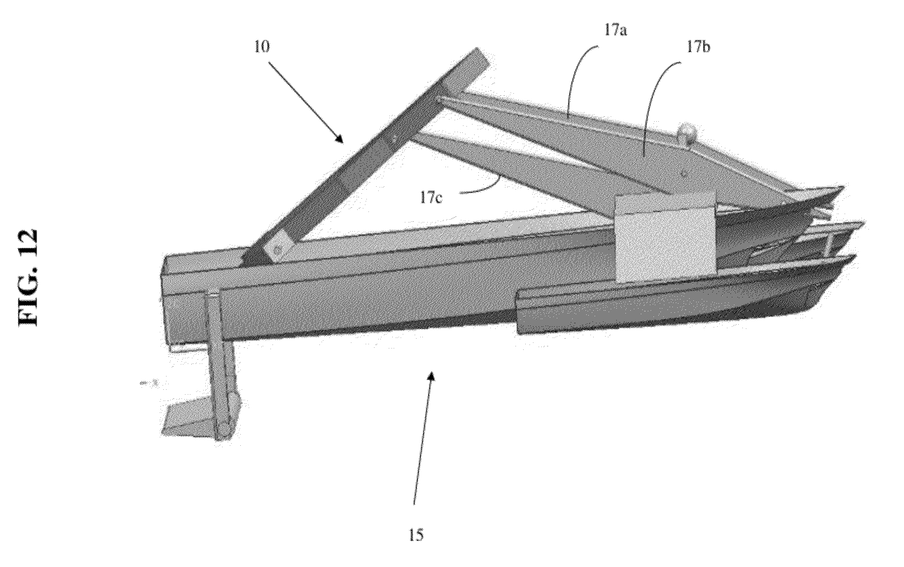

Referring to FIG. 12, initialization of the invention is shown. Booms 17a, 17b, 17c are hydraulically lifting rudder engaging component 10 from its folded inactive position on the deck of the high-speed small craft 15, to the active position shown in FIG. 1, where the invention projects from the bow of the small craft 15. Optionally, rudder engaging component 10 may remain in the folded inactive position as illustrated in FIG. 12 while high-speed small craft 15 travels rapidly towards the target vessel, to maximize the hydrodynamic nature of the small craft 15. Once the small craft 15 nears the target vessel, booms 17a, 17b, 17c hydraulically lift the rudder engaging component 10 from the deck, to the active position where rudder engaging component 10 projects from the bow of the small craft 15 and is advanced towards the rudder of the target vessel.

According to some embodiments, the invention may further include a drift anchor attached the rudder engaging component. Drift anchor may folded and attached to the rear end of the rudder engaging component (where arms 11a, 11b join one another). Drift anchor may then be deployed after rudder has been engaged or after propeller fouling element has been deployed, to increase drag and aid in slowing the moving vessel.

Having described the invention with regard to certain specific embodiments thereof, it is to be understood that the description is not meant as a limitation, as further modifications will now become apparent to those skilled in the art, and it is intended to cover such modifications as are within the scope of the appended claims.

1. An apparatus for reducing maneuverability of a moving ship, comprising: a propeller fouling element, mountable upon the bow of a second ship, wherein said proper fouling element is deployable towards a propeller of a ship.

2. The apparatus of claim 1, further comprising a rudder engaging component, mountable upon said second ship.

3. The apparatus of claim 2, wherein said rudder engaging component has an open position for accepting a rudder within, and an engaged position for holding a rudder within.

4. The apparatus of claim 2, wherein said rudder engaging component is U-shaped, having two arms for accepting a rudder within.

5. The apparatus of claim 2, further comprising a locking pin movable to engage said two arms and lock said rudder within.

6. The apparatus of claim 2, wherein said rudder engaging component is mountable upon an unmanned surface vehicle (USV).

7. The apparatus of claim 1, comprising an underwater camera for transmitting images of a rudder of said moving ship.

8. The apparatus of claim 2, wherein the angle and distance of said rudder engaging component from said second ship may be controlled by a user.

9. The apparatus of claim 1, wherein the angle and distance of said rudder propeller fouling element from said second ship may be controlled by a user.

10. The apparatus of claim 4, wherein said rudder engaging component arms are adjustable to be extended or retracted in any direction, to correspond to the length and width of the rudder of said moving ship.

11. The apparatus of claim 1, wherein said propeller fouling element is spear shaped.

12. The apparatus of claim 1, further comprising a propulsion mechanism for propelling said propeller fouling element towards a propeller.

13. The apparatus of claim 12, wherein said propulsion mechanism is selected from at least one of the following: compressed air, hydraulic pressure, pyrotechnic device, spring mechanism, and an electrical motor.

14. The apparatus of claim 1, comprising a plurality of propeller fouling elements.

15. The apparatus of claim 1, wherein said propeller fouling element comprises at least one of the following: a plurality of anchoring spikes; detonation elements, and a foam.

16. The apparatus of claim 2, wherein said rudder engaging component comprises a plurality of arms for engaging a rudder.

17. The apparatus of claim 2, wherein said rudder engaging component includes a mechanism for rapidly detaching said rudder engaging component from said second ship.

18. The apparatus of claim 2, wherein said rudder engaging component is self propelled.

19. The apparatus of claim 1, further comprising a timing mechanism for deployment of said propeller fouling element

20. The apparatus of claim 1, further comprising a deployment mechanism for deploying said propeller fouling element when a predetermined speed of said moving ship is reached.

21. The apparatus of claim 1, further comprising at least one of the following: an upper limiter for engaging the top portion of a rudder, and a deployable drift anchor.

22. The apparatus of claim 2, wherein said rudder engaging element is positional between a folded inactive position and an active position, wherein in said active position the rudder engaging element protrudes from the bow of said second ship.

23. The apparatus of claim 2, wherein said propeller fouling element includes a front portion deployable towards a propeller, a rear portion remaining attached to said rudder engaging component after deployment of said front portion, and a middle portion connecting between said front portion and said rear portion, such that after deployment of said front portion of said propeller fouling element, said propeller fouling element and said rudder engaging component remain in contact and jointly reduce maneuverability of a ship.

24. An apparatus for reducing maneuverability of a moving ship comprising a rudder engaging component having an open position for accepting a rudder within, and an engaged position for holding a rudder within; said apparatus including a propulsion mechanism.

25. A method for reducing maneuverability of a moving ship, comprising:
providing at least one of: a rudder engaging component or a propeller fouling element;
advancing said rudder engaging component to engage and surround said rudder of said ship; or advancing said propeller fouling element towards a propeller of a ship until said propeller fouling element contacts said propeller;
thereby reducing the maneuverability of said ship.
